(19) United States
(12) Patent Application Publication
(10) Pub. No.: US 2017/0325925 A1
(43) Pub. Date: Nov. 16, 2017

(54) FALSE TEETH FOR CATTLE AND SHEEP

(71) Applicant: ROOD MENTER, SUN CITY WEST, AZ (US)

(72) Inventor: ROOD MENTER, SUN CITY WEST, AZ (US)

(21) Appl. No.: 15/151,513

(22) Filed: May 11, 2016

(51) Int. Cl. A61D 5/00; A01K 29/00; A01K 13/00

(52) U.S. Cl. CPC A61D 5/00; A01K 13/00; A01K 29/00

(57) ABSTRACT

The present invention relates to the method for creating false teeth for animals which enables the prevention of teeth abrasion. This invention describes a hardening agent which when exposed to UV light source gets harden and create a protective covering over the teeth of the animal. This protective covering act as false teeth for animal and enable them to chew the food properly and thus secure their longer life span.

### FIELD OF THE INVENTION

The present invention relates to a method of applying a polymer on animal teeth to essentially create false teeth for enabling the prevention of teeth abrasion thereby securing longer life spans for them.

### BACKGROUND OF THE INVENTION

A cloven footed animal such as cattle and sheep has eight anterior teeth on the lower jaw. They are called the incisors. The upper jaw has no incisors on it. It is just a dental pad. The sole function of the incisor teeth is to cut grass. As the animal grows older these eight teeth wear down, or abrade off. When this happens the animal's useful life is over as it can no longer feed itself. At that time the animal is sold as a caner and cutter for its salvage value. How fast this happens is determined by the abrasion of the feed it is consuming. In different parts of the world the grass has different abrasion content. In South America, for instance, there is an abundance of wire grass that only allows an animal to live to be eight years old. Ranchers burn their grass off each year to keep the grass tenderer. Water grass in the gulf region of the U.S. is like sand paper and the life expectancy is curtailed. Yet in the mountain areas were an animal follows the snow melt in the spring and is then wintered on hay, they live twenty years

In relation to the value of a cow's teeth and standard financial practices for cattle raising every fall inventory of the herd is taken. Part of this practice of taking inventory involves inspecting the health of each cow's teeth. The reason this is done is to ensure the cow has not abraded its teeth to the point in which the teeth are worn to the gums. If the teeth are worn to the gums the cow is designated as caner and cutter cattle, as the cow will not have the ability to feed itself or a growing fetus in the coming months and will be frequently sold off as low grade meat to limit depreciation of the herd. In addition to limiting depreciation, money is only leant to a rancher based on the count of healthy cattle, and caner [symbol] cutter cattle do not usually meet this standard.

On a well maintained herd, the old caner [symbol] cutter cows each Fall make up about 10% of a cattle herd. If a rancher has a thousand cows, 100 cows will have to be replaced in the fall. A young breeding cow is worth $2,000. The salvage cow with abraded teeth is worth $400. So, you have a depreciation bill of $1,600×100 head equals $160,000. In the cattle business, 10% of your herd succumbs to becoming a glummer every year. They have to be replaced. This is a financial burden on the rancher. A caner and cutter cow is worth about $400. A replacement heifer is worth about $2,000. This is one of the biggest costs a rancher has to experience. This is why this invention is so paramount to the cattle industry. According to the U.S. Census Reports, there are 103 million untamed range cows and calves in the United States alone.

Presently, the various jaw molds provided for animals do not provide a permanent solution to tooth abrasion nor are they hygienically proven to be safe. They get dissolved in the saliva of the animals slowly and gently not providing a permanent solution to the problem wherein the health and longevity of a grazing animal, particularly bovine is directly related to the quality of their teeth. When the teeth wear down to the gums the animal's health cannot be insured nor can the animal be used at its highest value for financial purposes.

Currently, there is no safe adhesive that will bond to tooth enamel or stainless steel. Stainless steel being the only tough wearing material that was hygienically safe to put in an animal's mouth but there was no retention. Furthermore, each tooth had to be done individually. That took time and the animal had to be sedated. Under sedation a cow produces large quantities of saliva which did not allow for a dry working area. Moreover, grinding between teeth to fit the caps shortened the lives of the animals when the caps came off. Just one swipe of the cow's strong tongue would remove all the caps. In human dentistry caps are placed below the free marginal gum to harden the glue and keep the saliva out. It can't be done on a cow as their teeth are cone shaped rather than straight sided and each tooth is a different length.

In summation, gluing steel caps onto the animal's teeth does not provide a reliable solution. In order to apply these caps the animal would need to be sedated which could cause issues with saliva output and the animal usually becomes aggressive and dangerous while recovering from the effects of tranquilizers. Capping individual teeth is not satisfactory as it allows for grinding in-between the capped teeth.

Therefore, there remains a need to overcome above mentioned problems and the current invention described in this application does exactly that.

### SUMMARY OF THE INVENTION

The main objective of the present invention is to overcome the limitations of the prior arts by providing a method to apply false teeth for animals such as cattle and sheep enabling the prevention of teeth abrasion in animals thereby securing longer life spans for them.

The present invention relates to a method of applying a polymer which is a hardening agent to create false teeth or protective covering for the animal in order to stop their teeth abrasion. A cloven footed animal has eight anterior teeth on the lower jaw. They are called the incisors. The upper jaw has no incisors on it. These teeth for the animals perform the sole function of the incisor teeth which is to cut grass. As the animal grows older it wears down, or abrades off, these eight teeth. When this happens the animal's useful life is over as it can no longer feed itself. At that time the animal is sold as a caner and cutter for its salvage value. A cloven footed animal cuts the feed with her incisor teeth and swallows it immediately. Unlike humans, it is not masticated at that time. When the animal is resting and not grazing, it regurgitates the daily food and masticates it with their molar teeth. This is called chewing their cud.

The polymer which is a hardening agent adheres to the tooth enamel via a UV light source to form false teeth or a protective covering for the animal teeth. The created false teeth are not water soluble and also do not deteriorate with saliva. The process for creating these false teeth is time saving and is carried out manually. Further, this process does not require any experienced person to carry out the process and is done by any lay person with ordinary skills.

### BRIEF DESCRIPTION OF THE DRAWINGS

FIG. 1 illustrates the flow chart of the given invention according to an embodiment of the invention.

### DETAIL DESCRIPTION OF THE DRAWINGS

Reference will now be made in detail to the exemplary embodiment (s) of the invention, examples of which are illustrated in the accompanying drawings. Whenever possible, the same reference numerals will be used throughout the drawings to refer to the same or like parts.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent applications mentioned herein are incorporated herein in their entirety.

Further, in the present invention, the polymer is referred to a hardening agent, wherein the hardening agent creates protective covering or false teeth used to cover the teeth of the animals such as cattle and teeth but not limited to these only in order to prevent teeth abrasion or erosion.

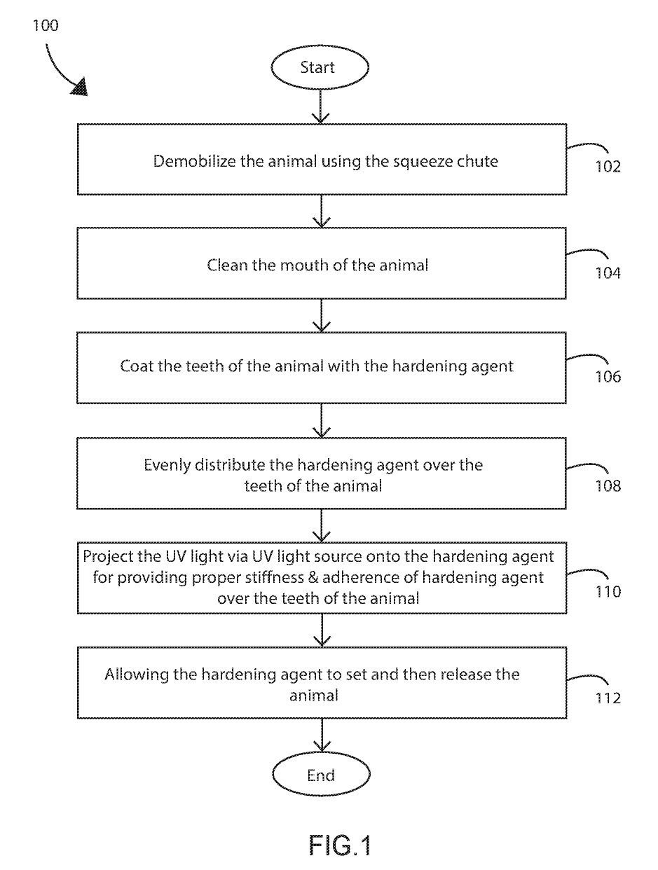

FIG. 1 illustrates the flow chart [100] which is also the preferred embodiment of the given invention and explains the method for the placement of the hardening agent onto the teeth of the animal to create false teeth. The method comprising the following steps:

STEP. 102 of FIG. 1 illustrates the demobilizing the animal in the squeeze chute. The animal is demobilized using a squeeze chute so that the animal does not move when the procedure is been carried out.

STEP. 104 of FIG. 1 illustrates cleaning the surface of teeth wherein, the cleaning provides wiping out moisture and debris from the animal mouth. This cleaning is done for ensuring proper application of hardening agent onto the anterior teeth of the animal to create false teeth. Since, this application of the hardening agent is a permanent process, proper cleaning of the teeth is important as any leftover leads to erosion of the hardening agent.

STEP. 106 of FIG. 1 illustrate pouring the hardening agent onto the animal teeth wherein the pouring ensures proper coverage of the animal teeth via hardening agent which when exposed to UV light source it gets harden, wherein the scope of the invention is not limited to only this.

STEP 108 of FIG. 1 illustrates evenly distributing the hardening agent over the teeth of the animal which enables the hardening agent to stick to the animal teeth for creating proper set of false teeth acting as a protective covering for preventing abrasion or erosion of the animal teeth.

STEP. 110 of FIG. 1 illustrate projecting the UV light via UV light source onto the hardening agent wherein, the UV light provides stiffness [symbol] adherence to the hardening agent so that the hardening agent gets proper texture and structure of the teeth to form proper false teeth for the animal.

STEP. 112 of FIG. 1 illustrate creating false teeth for animal teeth by allowing the hardening agent to set for some time after being exposed to UV light source. Once the proper adherence of the false teeth is ensured the animal is set free to eat the food.

This method of creating false teeth for the animals through the hardening agent is a hygienically safe, stops abrasion of the teeth, insulates the tooth nerve so the animal is able to drink cold water and do not deteriorate through saliva. It is a painless procedure which ensures that animal can cut the food properly thereby maintaining proper nutrition to the animal. This process also ensures that lactating animal eats properly and thus provides sufficient milk supply to its offspring.

This process also does not require a veterinarian or any skilled person to be carried out and can be done by any layman with normal skills. Herein all the 8 incisors teeth of the animal are protected at once and do not involve treating each tooth individually hence is a time saving process.

While the invention has been described in detail with specific reference to preferred embodiments thereof, it is understood that variations and modifications thereof may be made without departing from the true spirit and scope of the invention.

What is claimed is:

1- False teeth for preventing teeth erosion in an animal comprising:
a. a hardening agent, wherein the hardening agent is poured manually onto the teeth of the animal; and
b. at least one UV light source, wherein the UV light source is coupled to the hardening agent for providing stiffness.

2- The false teeth in claim 1; wherein the hardening agent is a polymer which acts like a protective covering enabling protection of eight anterior teeth on a lower jaw of the animal.

3- The false teeth in claim 1; wherein this hardening agent gets stiff when comes in contact with UV lights.

4- The false teeth in claim 1; wherein false teeth are not water soluble and do not deteriorate with the animal saliva.

5- The false teeth in claim 1; wherein the hardening agent adhere to the teeth and do not make use of any glue material to get adhere.

6- A method for creating false teeth for preventing teeth erosion in an animal comprising:
a. cleaning the surface of teeth wherein, the cleaning provides wiping out moisture and debris from the animal mouth;
b. pouring the hardening agent over the top of the teeth via any container manually; and
c. projecting the UV light via a source onto the hardening agent wherein, the UV light provides stiffness to the hardening agent.

7- The method in claim 6; wherein the hardening agent is a polymer which acts like a protective covering enabling protection of eight interior teeth on a lower jaw of the animal.

8- The method in claim 6; wherein this hardening agent gets stiff when comes in contact with UV lights.

9- The method in claim 6; wherein false teeth are not water soluble and do not deteriorate with the animal saliva.

10- The method in claim 6; wherein the hardening agent adhere to the teeth and do not make use of any glue material to get adhere.

11- The method in claim 6; wherein the method does not indulge any sedation to be given to the animal.

12- The method in claim 6; wherein the method is hygienically safe and is a painless procedure.

13. This entire process of putting a protective covering on the eight anterior teeth can be done in a matter of less than five minutes.

14. The polymer, which is a plastic material, can be programmed to be as hard as steel

15. The polymer can also be programmed to be flexible to fill gasps for missing teeth.
